(19) United States
(12) Patent Application Publication
(10) Pub. No.: US 2024/0056155 A1
(43) Pub. Date: Feb. 15, 2024

(54) REFERENCE SIGNAL PROCESSING FOR CHANNEL TIME DOMAIN PROPERTIES

(71) Applicant: Apple Inc., Cupertino, CA (US)

(72) Inventors: Haitong Sun, Cupertino, CA (US); Anchit Malhotra, Santa Clara, CA (US); David Neumann, Muenchen (DE); Dawei Zhang, Saratoga, CA (US); Ghaith N. Hattab, Santa Clara, CA (US); Ismael Gutierrez Gonzalez, San Jose, CA (US); Louay Jalloul, San Jose, CA (US); Wei Zeng, Saratoga, CA (US); Weidong Yang, San Diego, CA (US)

(73) Assignee: Apple Inc., Cupertino, CA (US)

(21) Appl. No.: 18/448,042

(22) Filed: Aug. 10, 2023

Related U.S. Application Data
(60) Provisional application No. 63/397,260, filed on Aug. 11, 2022.

(51) Int. Cl. H04B 7/06; H04W 72/12; H04W 72/232; H04W 72/21

(52) U.S. Cl. CPC H04B 7/0626; H04W 72/12; H04W 72/232; H04W 72/21

(57) ABSTRACT

The present application relates to devices and components including apparatus, systems, and methods for user equipment related design concepts for channel state information enhancement to exploit channel time-domain properties.

### RELATED APPLICATIONS

This application claims priority to U.S. Provisional Patent Application No. 63/397,260, filed Aug. 11, 2022, which is herein incorporated by reference in its entirety.

### FIELD

This application relates to the field of wireless networks and, in particular, to reference signal processing in said networks.

### BACKGROUND

Third Generation Partnership Project (3GPP) Technical Specifications (TSs) define standards for wireless networks. These TSs describe aspects related to measuring reference signals to determine channel state information

### BRIEF DESCRIPTION OF THE DRAWINGS

FIG. 1 illustrates a network environment in accordance with some embodiments.

FIG. 2 illustrates a burst in accordance with some embodiments.

FIG. 3 illustrates a signaling diagram in accordance with some embodiments.

FIG. 4 illustrates another signaling diagram in accordance with some embodiments.

FIG. 5 illustrates another signaling diagram in accordance with some embodiments.

FIG. 6 illustrates another signaling diagram in accordance with some embodiments.

FIG. 7 illustrates another signaling diagram in accordance with some embodiments.

FIG. 8 illustrates another signaling diagram in accordance with some embodiments.

FIG. 9 illustrates another signaling diagram in accordance with some embodiments.

FIG. 10 illustrates another signaling diagram in accordance with some embodiments.

FIG. 11 illustrates an operational flow/algorithmic structure in accordance with some embodiments.

FIG. 12 illustrates another operational flow/algorithmic structure in accordance with some embodiments.

FIG. 13 illustrates another operational flow/algorithmic structure in accordance with some embodiments.

FIG. 14 illustrates a user equipment in accordance with some embodiments.

FIG. 15 illustrates a base station in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit, a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/central processing unit time, processor/central processing unit usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element, or a data element that contains content. An information element may include one or more additional information elements.

3GPP Releases 15, 16, and 17 provide support for advanced channel state information (CSI) reporting by exploiting channel correlations. In Release 15, Type I and Type II CSI codebooks are defined to exploit a channel's spatial domain properties. In Release 16, enhanced Type II CSI codebook is supported to exploit both the channel's spatial domain properties and the channel's frequency domain properties. In Release 17, further enhancements to Type II CSI codebook are supported to exploit both the channel's spatial domain properties and the channel's frequency domain properties.

The correlation between uplink (UL) and downlink (DL) channels is used for reciprocity-based multiple-input, multiple-output (MIMO) communications. For UL operation, 5^{th} Generation (5G) New Radio (NR) supports non-codebook based physical uplink shared channel (PUSCH) operation. For DL operation, NR supports reporting of CSI-reference signal resource indicator (CRI), rank indicator (RI), and channel quality information (CQI) reporting. NR also supports Type II port selection codebook for DL operation.

Existing NR TSs do not adequately exploit a channel's time domain correlation for CSI reporting. A wireless channel typically varies over time, and a channel's coherence time may depend on relative movement speed of the communicating nodes and a rate of change of the environment itself.

A channel's time-domain correlation may be exploited to reduce network resource allocation and CSI report overhead, reduce UE power consumption, and provide more accurate adaptation to varying channel conditions.

CSI reporting enhancement by exploiting channel time domain properties is being considered with respect to developing Release 18 NR TSs.

Embodiments of the present disclosure provide user equipment (UE) processing related design for CSI enhancement to exploit a channel's time domain properties. Embodiments address aspects related to UE processing time requirement, UE CSI processing unit (CPU) occupation rule, and UE active CSI-RS rule.

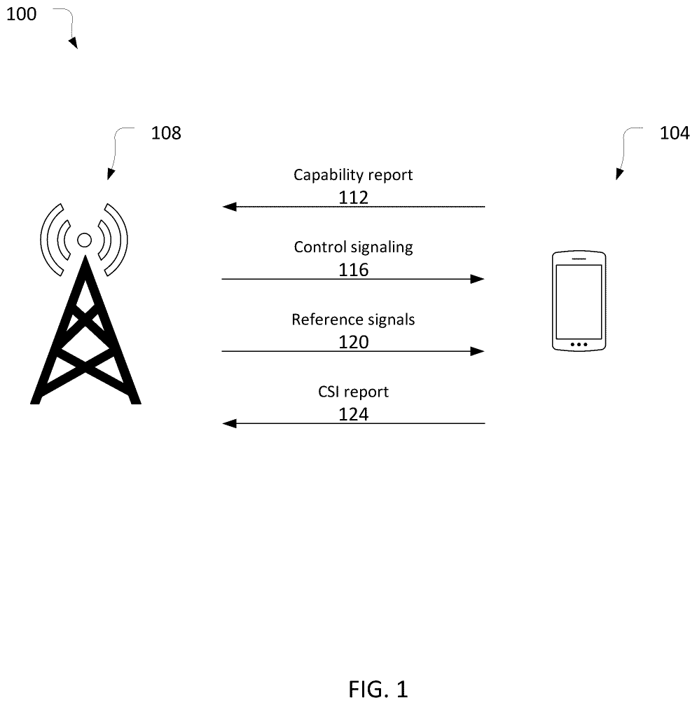

FIG. 1 illustrates a network environment 100 in accordance with some embodiments. The network environment 100 may include a user equipment 104 and a base station 108. In some embodiments, the base station 108 may provide one or more wireless access cells through which the UE 104 may communicate with a cellular network.

The UE 104 and the base station 108 may communicate over air interfaces compatible with 5G NR or later system standards as provided by 3GPP TSs. If the base station 108 is deployed in a 5G radio access network (RAN) it may also be referred to as gNB 108.

The network environment 100 introduces signaling that may occur between the UE 104 and the base station 108 in accordance with various embodiments of the present disclosure. Some embodiments may not have all of the signals represented in FIG. 1. Further, the signals may be reordered in some embodiments, and some signals shown generally as one message in FIG. 1 may be a plurality of messages transmitted at different times.

At 112, the UE 104 may transmit a capability report to the base station 108. The capability report may provide an indication of CSI processing capabilities of the UE 104.

At 116, the base station 108 may transmit control signaling to the UE 104. The control signaling may include information to configure and schedule CSI reports. This may include aspects related to the reference signals to be measured as a basis for the CSI reports. For example, the configuration information may provide an indication of channel measurement resources (CMRs) upon which reference signals may be transmitted for the purposes of measuring a channel and interference measurement resources (IMRs) that may be used for measuring interference. Further, the control signaling may provide information about whether the reference signals to be measured are CSI-reference signals (CSI-RSs) or synchronization signal and physical broadcast channel blocks (SSBs), and may indicate whether the CSI report is an aperiodic-CSI (AP-CSI) report, a periodic-CSI (P-CSI) report, or a semi-persistent-CSI (SP-CSI) report.

In general, a P-CSI report configures the UE 104 to periodically measure reoccurring reference signals and report on the measurements. An SP-CSI report is similar to the P-CSI report except that after the report is configured, the base station 108 may send a first media access control—control element (MAC-CE) to activate the report and a second MAC-CE to deactivate the report. An AP-CSI report is an individual report that is triggered as needed and has the potential to be a higher-resolution, lower-latency report.

The control signaling may also include DCI, in a physical downlink control channel (PDCCH) transmission, that schedules uplink resources for the AP-CSI report.

At 120, the base station 108 may transmit reference signals 120 to the UE 104. In contrast to current NR networks, in which a CSI measurement is based on a single CMR/IMR, the reference signals 120 may be transmitted in a burst to enhance the CSI reporting by exploiting channel time-domain properties.

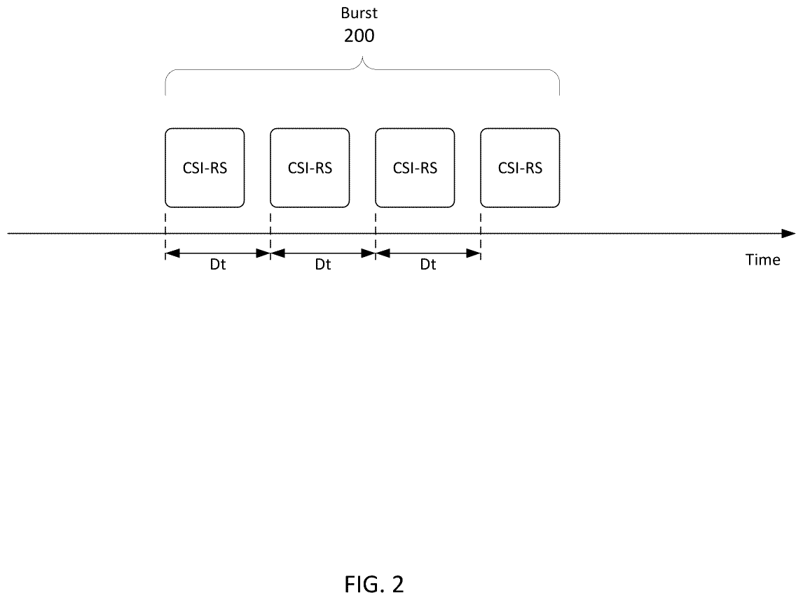

FIG. 2 illustrates a burst 200 in accordance with some embodiments. The burst 200 may include a plurality of CSI-RSs transmitted on a respective plurality of CMRs. A CMR may be one or more symbols that are configured for CSI measurement and reporting. Each burst may correspond to more than one CMR. Each CMR of the burst 200 may be separated from an adjacent burst by the same time-domain distance (shown in FIG. 2 as Dt). While FIG. 2 illustrates CSI-RSs transmitted on CMRs, other embodiments may include IMRs arranged as a burst and used in a similar manner for interference measurement and reporting.

In current networks, a UE processing time requirement for P-CSI or SP-CSI reporting may be four or five milliseconds. For AP-CSI, reporting, the UE processing time may be based on sets of CSI computation delay requirements. Each set may include Z and Z′. Z is defined as the time between an end of a PDCCH that triggers the AP-CSI and a beginning of the PUSCH that carries the AP-CSI. Z′ is defined as a time between an end of the last measurement resource and a beginning of the PUSCH that carries the AP-CSI.

The Z and Z′ values may be based on subcarrier spacing, p. For example, 3GPP TS 38.214 v17.2.0 (2022-June) includes Tables 5.4-1 and 5.4-2 to define four sets of CSI computation delay requirements as follows:

TABLE 5.4-1
CSI computation delay requirement 1

| | Z₁ [symbols] | |
|---|---|---|
| | Z₁ | Z₁′ |
| 0 | 10 | 8 |
| 1 | 13 | 11 |
| 2 | 25 | 21 |
| 3 | 43 | 36 |

TABLE 5.4-2
CSI computation delay requirement 2

| | Z₁ [symbols] | | Z₂ [symbols] | | Z₃ [symbols] | |
|---|---|---|---|---|---|---|
| μ | Z₁ | Z′₁ | Z₂ | Z′₂ | Z₃ | Z′₃ |
| 0 | 22 | 16 | 40 | 37 | 22 | X₆ |
| 1 | 33 | 30 | 72 | 69 | 33 | X₁ |
| 2 | 44 | 42 | 141 | 140 | min(44, X₂ + KB₁) | X₂ |
| 3 | 97 | 85 | 152 | 140 | min(97, X₃ + KB₂) | X₃ |
| 5 | 388 | 340 | 608 | 560 | min(388, X5 + KB3) | X5 |
| 6 | 776 | 680 | 1216 | 1120 | min(776, X6 + KB4) | X6 |

Table 5.4-1 is provided for low-latency CSI computations and Table 5.4-2 is provided for regular CSI computation. For regular CSI computation, Z1 and Z1′ are provided for low-complexity link adaptation-CSI (LA-CSI) or layer 1 (L1)—signal to interference and noise ratio (SINR); Z2 and Z2′ are provided for high-complexity LA-CSI; and Z3 and Z3′ are provided for L1—reference signal received power (RSRP) measurement (for example, beam management-CSI (BM-CSI)).

Given that the UE processing time requirements are provided for individual CSI measurements/reports that correspond to a channel state at a single time instance, the requirements may be further considered in light of the enhanced CSI measurements/reports that capture time-domain correlations of a channel.

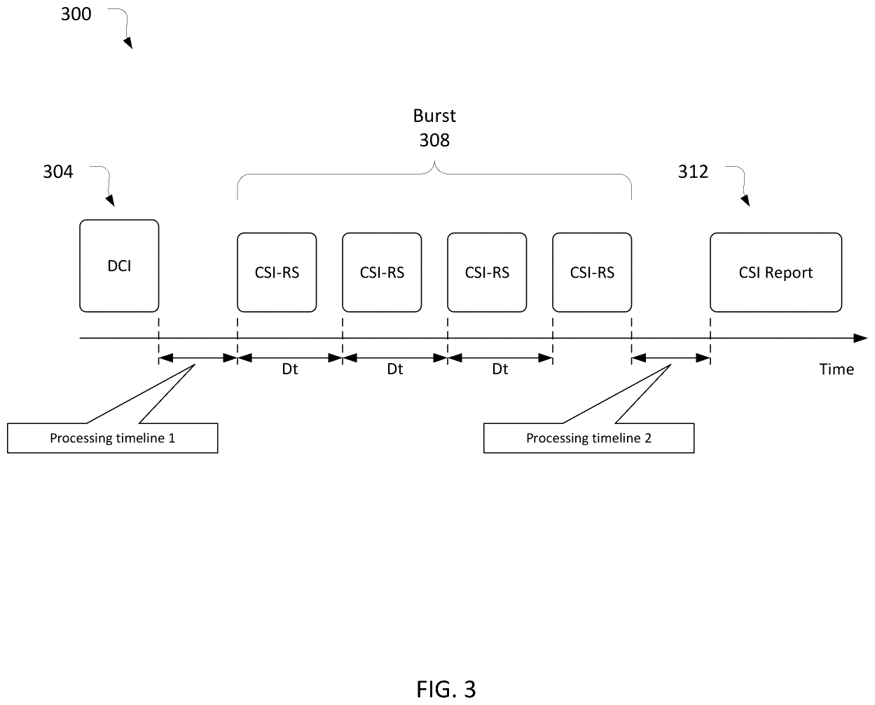

FIG. 3 is a signaling diagram 300 illustrating concepts related to UE processing time requirements in accordance with some embodiments. The signaling diagram 300 may represent a scenario in which the UE 104 is configured with enhanced CSI reporting to exploit a channel's time domain properties.

The signaling diagram 300 includes DCI 304 that schedules a CSI report. The DCI 304 may be transmitted from the base station 108 to the UE 104. The signaling diagram 300 may further include a burst 308 that includes CSI-RSs transmitted by the base station 108 on corresponding CMRs. Configuring the CSI measurement over the burst of CSI-RSs may enable observation of the channel's time-domain properties as described elsewhere herein. The UE 104 may measure the CSI-RSs and, in some instances, perform initial processing on the measurements to determine various time-domain aspects of the channel. The UE 104 may prepare a CSI report 312 that is transmitted to the base station 108 via a PUSCH transmission.

The beginning of the first reference signal of the burst 308 in the time domain may be used as the reference time that corresponds to aspects of 3GPP TSs, such as TS 38.214, that refer to the beginning of an RS. For example, the beginning of the first CSI-RS of the burst 308 (the leftmost CSI-RS shown in FIG. 3), may be used as the basis for determining the earliest time the base station 108 can schedule transmission of an AP-CSI-RS. The first CSI-RS may not be transmitted earlier than the DCI 304 to allow for processing timeline 1 that may be used for the UE 104 to start monitoring/measuring CSI-RSs after receiving the DCI 304.

The end of the last reference signal of the burst 308 in the time domain may be used as the reference time that corresponds to aspects of 3GPP TSs, such as TS 38.214, that refer to the end of the RS. For example, the end of the last CSI-RS of the burst 308 (the rightmost CSI-RS shown in FIG. 3), may be used as the basis for determining the earliest time the base station 108 can schedule transmission of the CSI report 312. This is shown generally as processing timeline 2, which may correspond to a CSI processing time line or a uplink control information (UCI) multiplexing time line. An end of the last CSI-RS of the burst 308 may additionally/alternatively be used for an aperiodic nonCodebook sounding reference signal (SRS) transmission timeline.

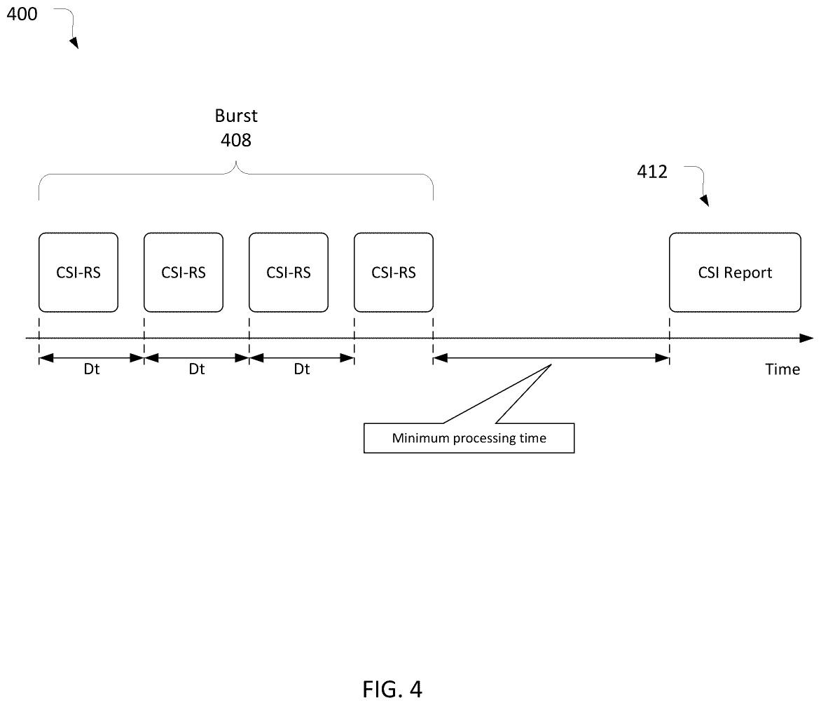

FIG. 4 illustrates a signaling diagram 400 in accordance with some embodiments. The signaling diagram 400 may be used to describe UE processing time requirements when CSI measurement is configured over a burst of reference signals for P-CSI reports or SP-CSI reports.

The signaling diagram 400 includes a burst 408 having CSI-RSs transmitted by the base station 108 on corresponding CMRs. The UE 104 may measure the CSI-RSs and, in some instances, perform initial processing on the measurements to determine various time-domain aspects of the channel. The UE 104 may prepare a CSI report 412 that is transmitted to the base station 108 via a PUSCH transmission.

A minimum processing time may be defined between the last reference signal of the burst 408 and the CSI report 412. In some embodiments, the minimum processing time may be set to 4 or 5 milliseconds. The base station 108 may schedule the burst 408 and the CSI report 412 in a manner to maintain at least this amount of time-domain separation to allow for the UE 104 to perform any desired processing of the measurements performed on the CSI-RSs and prepare the CSI report.

In other embodiments, the UE 104 may report a desired processing time based on its capability. For example, the processing time may be provided in the capability report 112 of FIG. 1. The desired processing time may be reported in accordance with one of the following two options.

In a first option, the UE 104 may only report one value in units of milliseconds or symbols. This may be independent from an SCS used for DL/UL channels/signals.

In a second option, the UE 104 may report a value (in milliseconds or symbols) corresponding to each of a plurality of SCSs. For example, a first value may correspond to an amount of time the UE needs to process the CSI if a first SCS were used, etc. The base station 108 may, upon receiving the different processing time values, select one of the processing time values to determine the minimum processing time to use for the scheduling of the burst 480 or CSI report 412. The base station 108 may select the processing time value that corresponds to an SCS of the DL channel/signal, or may select a processing time value that corresponds to a minimum SCS of the DL and UL channel/signals. Selecting the processing time value that corresponds to the minimum SCS may result in the selection of a relatively larger processing time value.

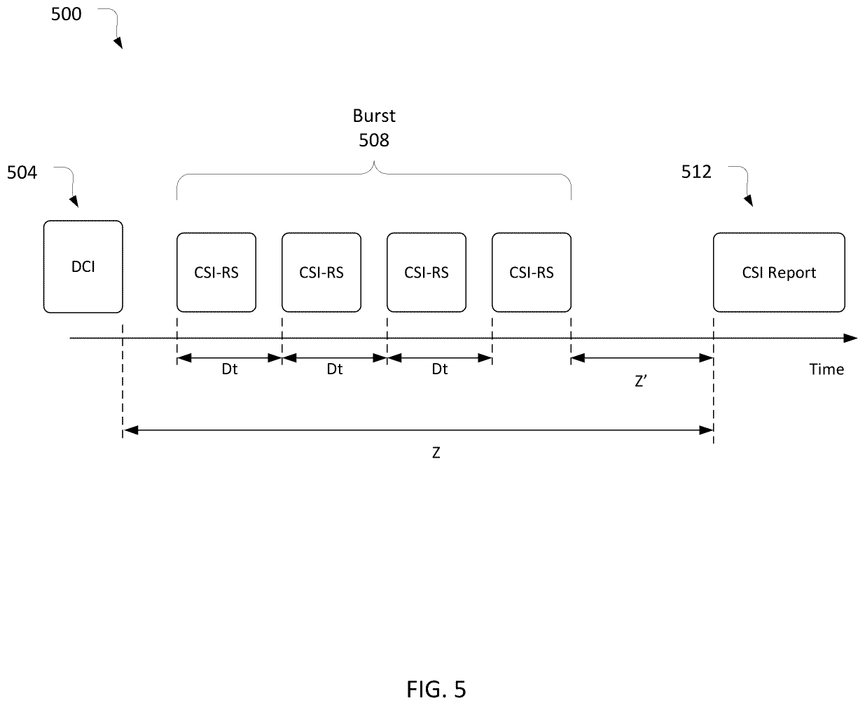

FIG. 5 illustrates a signaling diagram 500 in accordance with some embodiments. The signaling diagram 500 may be used to describe UE processing time requirements when CSI measurement is configured over a burst of reference signals for aperiodic CSI (AP-CSI).

The signaling diagram 500 includes DCI 504 that schedules an AP-CSI report. The DCI 504 may be transmitted from the base station 108 to the UE 104. The signaling diagram 500 may further include a burst 508 that includes CSI-RSs transmitted by the base station 108 on corresponding CMRs. Configuring the CSI measurement over the burst of CSI-RSs may enable observation of the channel's time-domain properties as described elsewhere herein. The UE 104 may measure the CSI-RSs and, in some instances, perform initial processing on the measurements to determine various time-domain aspects of the channel. The UE 104 may prepare a CSI report 512 that is transmitted to the base station 108 via a PUSCH transmission.

The signaling diagram shows CSI computation delay requirements Z and Z′. Z may be defined as the time between the DCI 504 and the CSI report 512, and Z′ may be defined as the time between a last CSI-RS of the burst 508 and the CSI report 512.

In some embodiments, the enhanced CSI measurements based on the CSI-RS bursts may be considered incompatible with the low-latency CSI reports. Thus, in these embodiments, the UE 104 may not be expected to support the low-latency CSI reports and the associated CSI computation delay requirements (as shown in Table 5.4-1 above, for example).

In other embodiments, the UE 104 may support low-latency CSI reports with respect to the enhanced CSI measurements. The UE 104 may report an indication of whether it supports low-latency CSI report based on a burst of multiple RSs. For example, this indication may be part of the capability report 112 discussed above with respect to FIG. 1.

In the event the UE 104 is configured for a low-latency CSI report based on a burst of multiple RSs, it may be desirable to provide some limitations on its application or with respect to the triggered report to ensure compatibility of both the low-latency objectives with the time-domain observation of the channel. For example, in some embodiments, the low-latency CSI report based on a burst of multiple RSs may not be appropriate when SCSs above 120 kHz are involved in the AP-CSI process. The higher frequency ranges associated with such SCSs may not afford the desired timelines for the enhanced low-latency AP-CSI measurement/reporting.

In some embodiments, the PUSCH that carries a low-latency AP-CSI may not be scheduled to carry uplink data of an uplink shared channel (UL-SCH), nor would the PUSCH carry hybrid automatic repeat request (HARQ)-acknowledgment (ACK) information.

Still further, the UE 104 may not be expected to multiplex any other UCI on the PUSCH that carries the low-latency AP-CSI.

In some embodiments, when the UE 104 is configured for low-latency AP-CSI, it may dedicate its processing resources to that task. For example, no other CPU may be occupied simultaneously with the CPU(s) dedicated to processing the AP-CSI-RS resources.

The UE processing time requirements for enhanced CSI measurements based on CSI-RS bursts for AP-CSI reports with normal latency (for example, corresponding to Table 5.4-2 in 3GPP TS 38.214) may be handled as follows.

In a first option, to allow for more time to accommodate the burst 508, selection of the CSI computation delay requirements may be restricted to Z2/Z2′ and Z3/Z3′. Z1/Z1′ may not be allowed in this option as its relatively short timeline may not provide the UE 104 with sufficient time to measure and process the burst 508.

The base station 108 may determine whether to use Z2/Z2′ or Z3/Z3′ based on whether the CSI report 512 is for LA-CSI or BM-CSI. If the CSI report 512 is for LA-CSI, the base station 108 may use Z2/Z2′ to determine the UE processing requirements. If the CSI report 512 is for BM-CSI, the base station 108 may use Z3/Z3′ to determine the UE processing requirements.

In a second option, Z1/Z1′, Z2/Z2′, or Z3/Z3′ may be selected as the CSI computation delay requirements.

The base station 108 may determine whether to use Z1/Z1′, Z2/Z2′, or Z3/Z3′ based on complexity of the CSI report 512 and whether the CSI report 512 is for LA-CSI or BM-CSI. If the CSI report 512 is for relatively low-complexity LA-CSI, the base station 108 may use Z1/Z1′ to determine the UE processing requirements. If the CSI report 512 is for relatively high-complexity LA-CSI, the base station 108 may use Z2/Z2′ to determine the UE processing requirements. If the CSI report 512 is for BM-CSI, the base station 108 may use Z3/Z3′ to determine the UE processing requirements.

In some embodiments, the UE 104 may report an additional relaxation value to accommodate enhanced AP-CSI reporting when CSI measurement is configured over a burst of reference signals. The relaxation value may be reported with a unit of symbols. The base station 108 may add the relaxation value to the CSI computation delay requirements (Z/Z′) in order to determine processing requirements for the UE 104.

In some embodiments, one value may be provided for the relaxation parameter. In other embodiments, a relaxation value may be provided for each of the plurality of different SCSs. The base station 108 may then determine which relaxation value to use based on the configured SCSs. For example, the base station 108 may use the relaxation value that corresponds to the SCS that is the minimum SCS among the DCI 504, the burst 508, or the PUSCH that carries the CSI report 512.

The UE 104 may provide to the base station 108 an indication of a number of simultaneous CSI calculations it is capable of performing per component carrier (CC) and across all CCs. This information may be provided to the base station 108 in the capability report 112 of FIG. 1, for example. The number of simultaneous CSI calculations supported by the UE 104 may also be referred to as a number of CPUs of the UE 104. Processing a CSI report that is based on measurements of a burst of reference signals may occupy one or more CPUs of the UE 104 based on one or more of the following options.

In a first option, the number of CPUs occupied for processing a CSI report may be set equal to a number of configured CMRs per burst. For example, with reference to FIG. 5, it make take four CPUs to process the CSI report 512 given that there are four CMRs in the burst 508.

In a second option, the number of CPUs occupied for processing a CSI report may be predetermined as a fixed number per burst. The fixed number may be defined by a 3GPP TS, for example. For example, a 3GPP TS may indicate that one CPU is occupied to process a CSI report corresponding to a burst. In some embodiments, a number of different values may be predefined for a number of different burst sizes. For example, one CPU is occupied to process a CSI report corresponding to a burst of two CMRs, two CPUs are occupied to process a CSI report corresponding to a burst of six CMRs, etc.

In a third option, the UE 104 may report a number of CPUs occupied per burst. For example, the UE 104 may indicate that one CPU is occupied to process a CSI report based on a four-burst CMR. This may provide a mapping between a number of CMRs configured per burst and a corresponding number of occupied CPUs. Said another way, the UE 104 may report how many CMRs the UE 104 is capable of handling per CPU. This capability may be provided to the base station 108 in the capability report 112 of FIG. 1, for example, along with the number of total CPUs supported by the UE 104 per CC or across all CCs.

To further illustrate concepts of the third option, consider a situation in which the UE 104 provides a first indication that it supports 8 CPUs across all CCs, and a second indication that it can process 4 CMRs with 1 CPU. If the base station 108 configures the UE 104 with a burst with 4 CMRs, it may understand that it has 7 remaining CPUs that it may use for configuring additional CSI reports.

In some embodiments, if a low-latency AP-CSI report is configured based on a burst of CMRs, the low-latency AP-CSI report may be considered to occupy all the CPUs supported by the UE 104. In this manner, the UE 104 may dedicate its processing resources to quickly turning around the low-latency AP-CSI report.

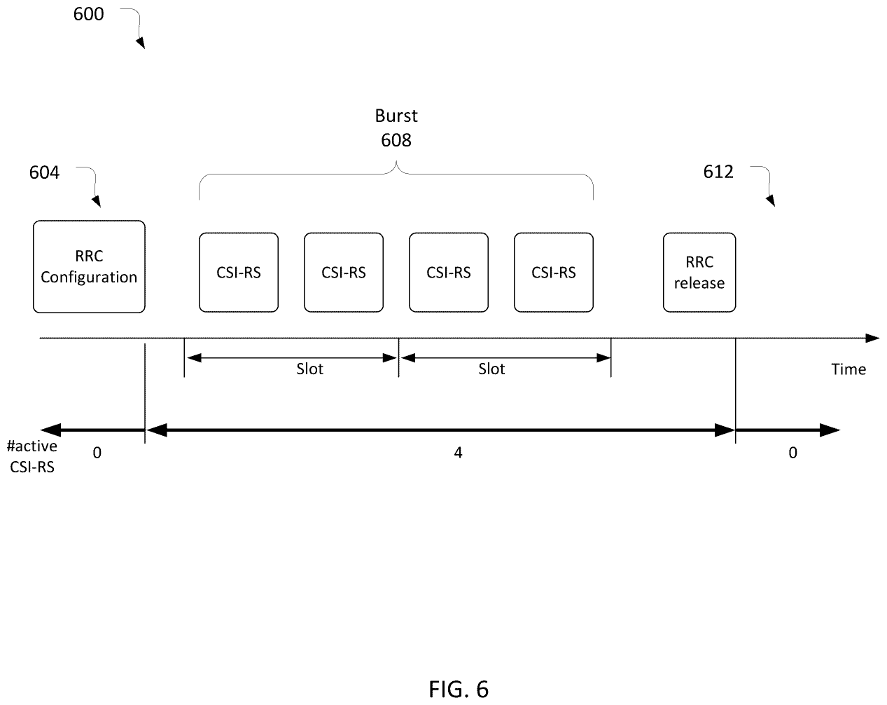

In some embodiments, the UE 104 may report a number of active CSI-RS resources in active BWPs that it is capable of supporting. This capability may be provided to the base station 108 in the capability report 112 of FIG. 1, for example. The base station 108 may configure non-zero power (NZP) CSI-RS resources within a duration of time in a manner to be within this capability. When the base station 108 has configured CSI measurement over a burst of CMRs, it may ensure that the NZP-CSI-RS resources used for the enhanced CSI report that occupy an active CSI-RS are no more than the indicated capability. The NZP-CSI-RS resources that occupy an active CSI-RS are those that are within a duration of time determined as described in FIGS. 6-8 as follows.

FIG. 6 illustrates a signaling diagram 600 in accordance with some embodiments. The signaling diagram 600 may be used to describe identifying NZP-CSI-RS resources that occupy an active CSI-RS when CSI measurement is configured over a burst of reference signals for P-CSI.

The signaling diagram 600 includes an RRC configuration 604 that configures a P-CSI report. The signaling diagram 600 may further include a burst 608 that includes CSI-RSs transmitted by the base station 108 on corresponding CMRs. The first two CMRs of the burst 608 may be within a first slot and the second two CMRs of the burst 608 may be within a second slot. The signaling diagram 600 further includes an RRC release 612 that releases the P-CSI report.

In this embodiment, the periodic NZP-CSI-RS resources may be considered to occupy an active CSI-RS if they occur within a duration of time that starts when the periodic CSI-RS is configured by higher-layer signaling (for example, RRC configuration 604) and ends when the periodic CSI-RS configuration is released by RRC release 612. As shown, NZP-CSI-RS resources corresponding to the four CMRs of the burst 608 may be considered to occupy the active CSI-RS.

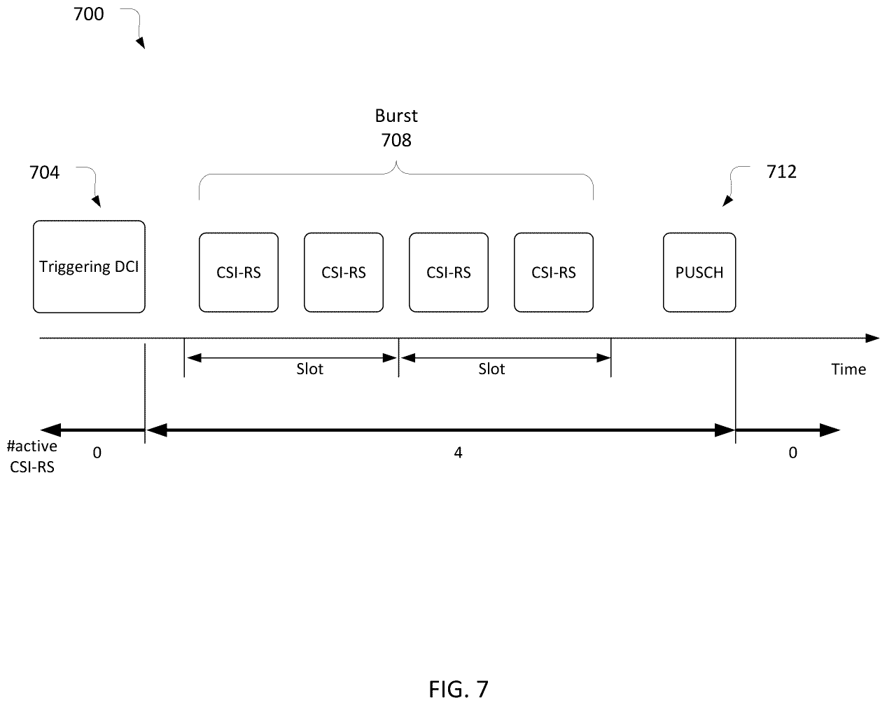

FIG. 7 illustrates a signaling diagram 700 in accordance with some embodiments. The signaling diagram 700 may be used to describe identifying NZP-CSI-RS resources that occupy an active CSI-RS when CSI measurement is configured over a burst of reference signals for P-CSI.

The signaling diagram 700 includes a triggering DCI 704 that triggers and schedules an AP-CSI report. The signaling diagram 700 may further include a burst 708 that includes CSI-RSs transmitted by the base station 108 on corresponding CMRs. The first two CMRs of the burst 708 may be within a first slot and the second two CMRs of the burst 708 may be within a second slot. The signaling diagram 700 further includes a PUSCH 712 that includes the AP-CSI report.

In this embodiment, the aperiodic NZP-CSI-RS resources may be considered to occupy an active CSI-RS if they occur within a duration of time that starts from an end of the PDCCH containing the request (for example, the triggering DCI 704) and ends at an end of the scheduled PUSCH containing the report associated with this aperiodic CSI-RS (for example, the PUSCH 712. As shown, NZP-CSI-RS resources corresponding to the four CMRs of the burst 708 may be considered to occupy the active CSI-RS.

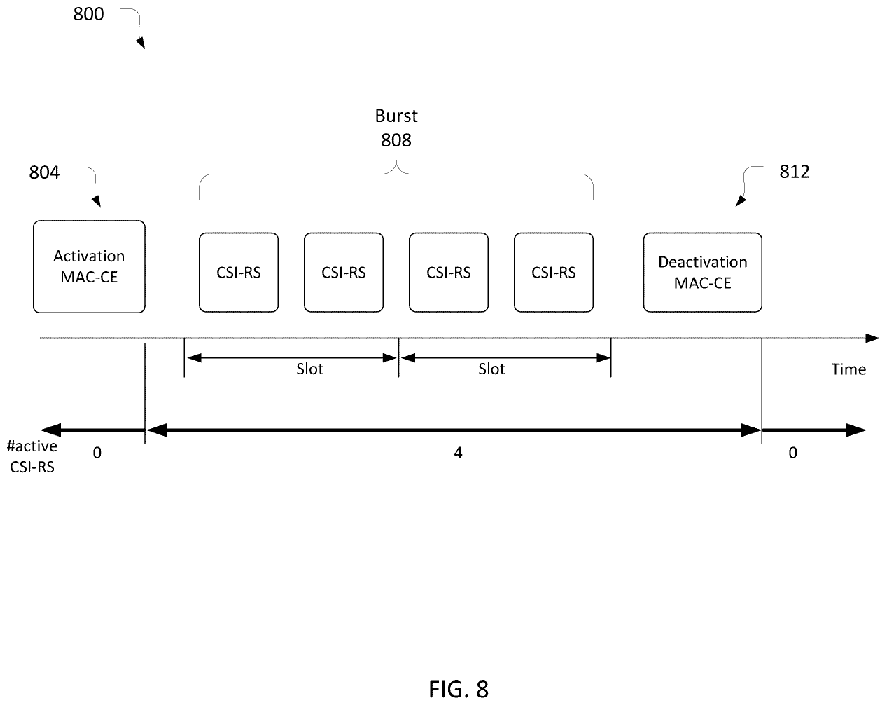

FIG. 8 illustrates a signaling diagram 800 in accordance with some embodiments. The signaling diagram 800 may be used to describe identifying NZP-CSI-RS resources that occupy an active CSI-RS when CSI measurement is configured over a burst of reference signals for SP-CSI.

The signaling diagram 800 includes an activation MAC-CE 804 that activates a configured SP-CSI report. The signaling diagram 800 may further include a burst 808 that includes CSI-RSs transmitted by the base station 108 on corresponding CMRs. The first two CMRs of the burst 808 may be within a first slot and the second two CMRs of the burst 808 may be within a second slot. The signaling diagram 800 further includes a deactivation MAC-CE 812 that deactivates the configured SP-CSI report.

In this embodiment, the semi-persistent NZP-CSI-RS resources may be considered to occupy an active CSI-RS if they occur within a duration of time that starts from an end of when the activation command is applied (for example, after the activation MAC-CE 804) and ends at an end of when the deactivation command is applied (for example, the after the deactivation MAC-CE 812). As shown, NZP-CSI-RS resources corresponding to the four CMRs of the burst 808 may be considered to occupy the active CSI-RS.

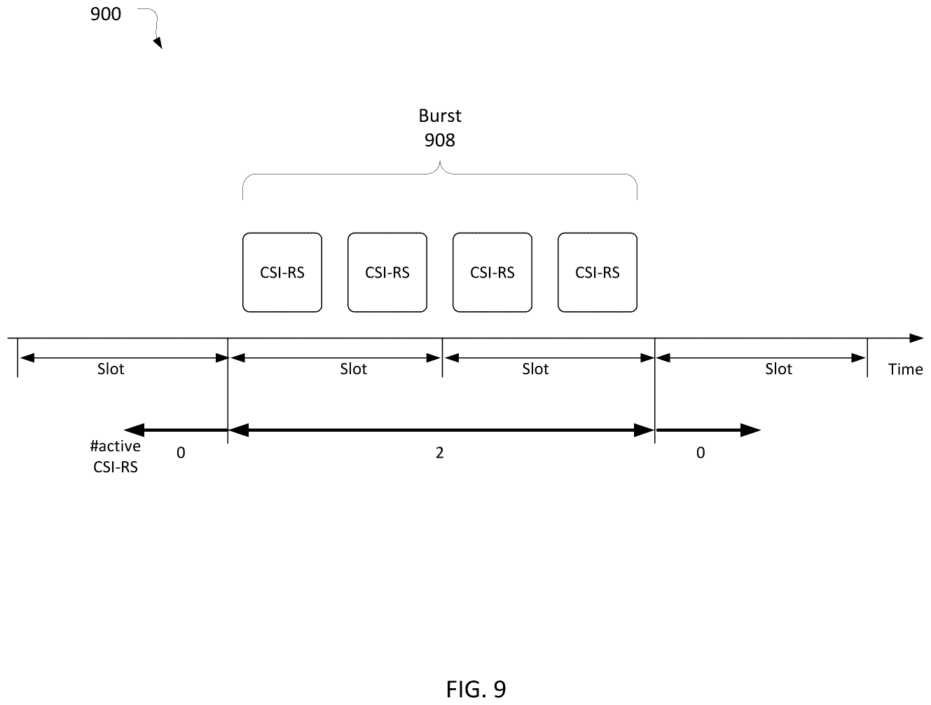

FIG. 9 illustrates a signaling diagram 900 in accordance with some embodiments. The signaling diagram 900 may be used to describe identifying NZP-CSI-RS resources that occupy an active CSI-RS when CSI measurement is configured over a burst of reference signals for various CSI reports. In this embodiment, only the slot in which the NZP-CSI-RS resources are transmitted may be considered for the active CSI-RS.

The signaling diagram 900 includes a burst 908 that includes CSI-RSs transmitted by the base station 108 on corresponding CMRs. The first two CMRs of the burst 908 may be within a first slot and the second two CMRs of the burst 908 may be within a second slot.

In this embodiment, only the NZP-CSI-RS resources that occur in a slot may be considered to occupy an active CSI-RS. As shown, NZP-CSI-RS resources corresponding to the two CMRs of the burst 808 may be considered to occupy the active CSI-RS as each slot only includes two CMRs.

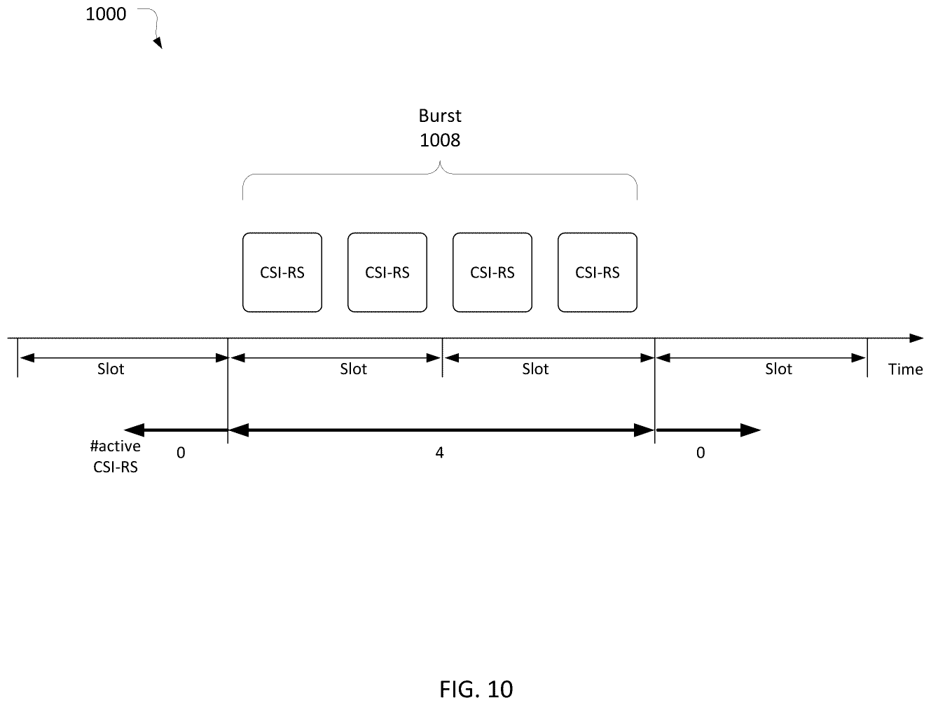

FIG. 10 illustrates a signaling diagram 1000 in accordance with some embodiments. The signaling diagram 1000 may be used to describe identifying NZP-CSI-RS resources that occupy an active CSI-RS when CSI measurement is configured over a burst of reference signals for various CSI reports. In this embodiment, only the burst in which the NZP-CSI-RS resources are configured may be considered for the active CSI-RS

The signaling diagram 1000 includes a burst 1008 that includes CSI-RSs transmitted by the base station 108 on corresponding CMRs. The first two CMRs of the burst 1008 may be within a first slot and the second two CMRs of the burst 1008 may be within a second slot.

In this embodiment, only the NZP-CSI-RS resources that occur in a burst may be considered to occupy an active CSI-RS. As shown, NZP-CSI-RS resources corresponding to the four CMRs of the burst 808 may be considered to occupy the active CSI-RS.

The active CSI-RS rule described with respect to FIG. 9 and FIG. 10 may be more appropriate for measurements have relatively limited complexity. These measurements may include, for example, L1-RSRP measurements, L1-SINR measurements, pathloss measurements, beam failure detection (BFD) measurements, radio link monitoring (RLM) measurements, and new beam identification (NBI) measurements. However, these rules may be applied to other measurements in other embodiments.

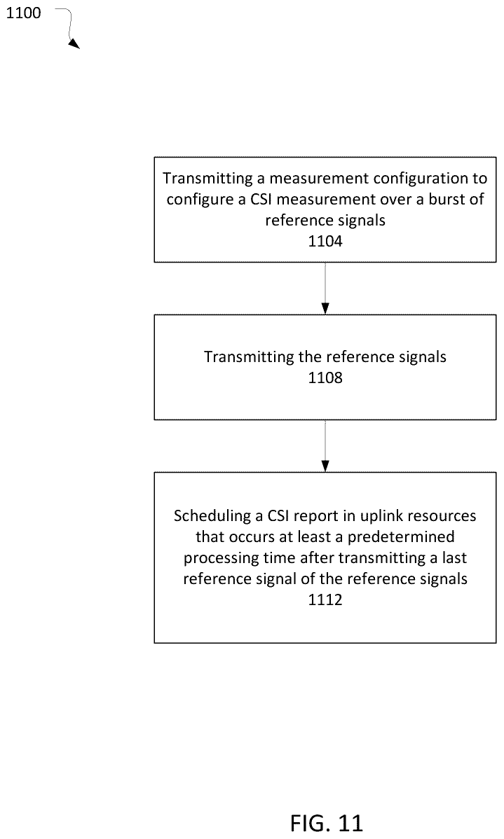

FIG. 11 includes an operation flow/algorithmic structure 1100 in accordance with some embodiments. The operation flow/algorithmic structure 1100 may be performed or implemented by a device such as, for example, base station 108 or base station 1500; or components thereof, for example, processors 1504.

The operation flow/algorithmic structure 1100 may include, at 1104, transmitting a measurement configuration to configure a CSI measurement over a burst of reference signals. The CSI measurement may be configured for enhanced CSI reporting to exploit time-domain properties of the channel.

The operation flow/algorithmic structure 1100 may further include, at 1108, transmitting the reference signals. The reference signals may be CSI-RSs or SSBs. The reference signals of the burst may be transmitted at CMRs or IMRs that occur at predetermined intervals. The burst may include any number of reference signals based on desired objectives of a particular embodiment.

The operation flow/algorithmic structure 1100 may further include, at 1112, scheduling a CSI report and uplink resources that occurs at least a predetermined processing time after transmitting a last reference signal of the reference signals. The last reference signal may be the last-occurring reference signal within a time-domain sequence of the burst of reference signals.

In some embodiments, the predetermined processing time may be designed to accommodate CSI processing, UCI multiplexing, or SRS transmissions performed by the UE. In some embodiments, the predetermined processing time may be set to four or 5 ms. In other embodiments, the predetermined processing time may be based on a UE capability report received from the UE. The UE capability report may provide a value, in milliseconds, that the base station may use as the predetermined processing time. Additionally/alternatively, the UE capability report may provide a plurality of values that respectively correspond to a plurality of SCSs. The base station may determine the SCS of a representative channel or signal and select the value that corresponds to the SCS as the predetermined processing time. In some instances, the SCS may be the smallest SCS of the downlink or uplink channel.

If the CSI report is an AP-CSI report, the base station may schedule the CSI report based on CSI computation delay requirements (for example, Z and Z′ as discussed elsewhere herein). In some embodiments, the selection of the CSI computation delay requirements may be limited to low-complexity link adaptation CSI computation requirements, high-complexity link adaptation CSI computation requirements, or beam management CSI computation requirements. That is, low-latency CSI computation requirements may not be available. In other embodiments, the low-latency CSI computation requirements may be available for selection.

In some embodiments, the base station may schedule the AP-CSI report based on a relaxation value provided by the UE in, for example, a capability report. The relaxation value may indicate a number of symbols, which may be added to the CSI computation requirements selected for a particular CSI report. In some embodiments, the UE may report a plurality relaxation values corresponding to a respective plurality of SCSs. The base station may then select one of the relaxation values based on a representative SCS. The representative SCS may be the smallest value from an SCS associated with DCI that schedules the CSI report, an SCS associated with the PUSCH transmission that carries the CSI report, or an SCS associated with the plurality of reference signals.

If AP-CSI report is used for low-latency CSI, content of the PUSCH transmission that carries the CSI report may be restricted. For example, the PUSCH transmission may not carry uplink shared channel data or HARQ information. Additional/alternative restrictions may be applied to low-latency AP-CSI reports. For example, the CSI report may not be expected to be multiplexed with other UCI in the PUSCH transmission, the CSI report may be associated with an SCS that is less than 120 kHz, and, while measuring the plurality of reference signals in the burst in one or more CPUs, the UE may not be expected to perform any other CSI measurements in any other CPUs.

In some embodiments, the scheduling of the CSI report may be communicated through a measurement configuration, for example, provided at 1104. This may be the case if the CSI report is a P-CSI report, for example. In other embodiments, the scheduling of the CSI report may be through DCI if, for example, the CSI report is an AP-CSI report. If the CSI report is scheduled through DCI, the DCI may not be transmitted before the first reference signal of the reference signals. The first reference signal may be the first-occurring reference signal within the time-domain sequence of the burst of reference signals.

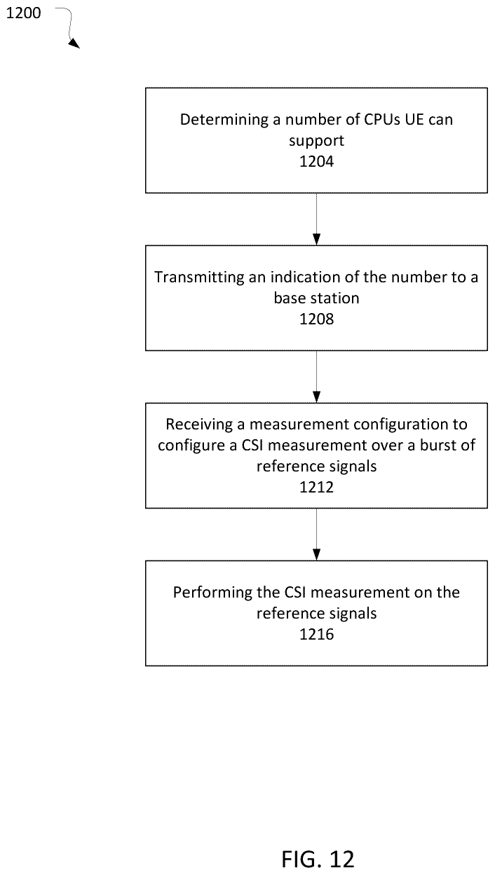

FIG. 12 includes an operation flow/algorithmic structure 1200 in accordance with some embodiments. The operation flow/algorithmic structure 1200 may be performed or implemented by a device such as, for example, UE 104 or UE 1400; or components thereof, for example, processors 1404.

The operation flow/algorithmic structure 1200 may include, at 1204, determining a number of CPUs that the UE can support. The number of CPUs supportable by the UE may be based on processing capabilities of the UE. The number may generally correspond to the number of simultaneous CSI measurements that may be performed by the UE.

The operation flow/algorithmic structure 1200 may further include, at 1208, transmitting an indication of the number to a base station. The indication may be transmitted in a UE capability report.

In some embodiments, the UE may also determine a number of CMRs that the UE is capable of measuring per CPU. This number may also be reported to the base station. This number may be reported together or separate from the number of supported CPUs.

The operation flow/algorithmic structure 1200 may further include, at 1212, receiving a measurement configuration to configure a CSI measurement over burst of reference signals. The CSI measurement may be configured for enhanced CSI reporting to exploit time-domain properties of the channel.

The operation flow/algorithmic structure 1200 may further include, at 1216, performing the CSI measurement on the reference signals. The UE may further process the measurements and generate a CSI report that may be transmitted to the base station.

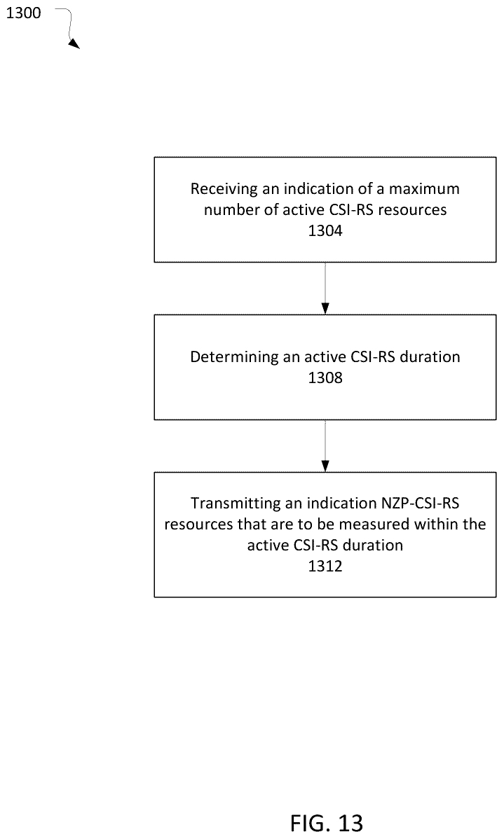

FIG. 13 includes an operation flow/algorithmic structure 1300 in accordance with some embodiments. The operation flow/algorithmic structure 1300 may be performed or implemented by a device such as, for example, base station 108 or base station 1500; or components thereof, for example, processors 1504.

The operation flow/algorithmic structure 1300 may include, at 1304, receiving an indication of a maximum number of active CSI-RS resources the UE is capable of supporting.

The operation flow/algorithmic structure 1300 may further include, at 1308, determining an active CSI-RS duration. The endpoints of the active CSI-RS duration may depend on the type of CSI report to be configured by the base station. For example, if the CSI report is a P-CSI report, the duration may extend from the RRC configuration that configures the P-CSI report to an RRC release message that releases the P-CSI report. If the CSI report is an AP-CSI report, the duration may extend from a DCI that triggers the AP-CSI report to a PUSCH transmission that carries the AP-CSI report. If the CSI report is an SP-CSI report, the duration may extend from a MAC-CE that activates the SP-CSI report to a MAC-CE that deactivates the SP-CSI report.

The operation flow/algorithmic structure 1300 may further include, at 1312, transmitting an indication of NZP-CSI-RS resources that are to be measured within the active CSI-RS duration. The number of NZP-CSI-RS resources configured may be less than the maximum number of active CSI-RS resources received at 1304.

In some embodiments, the NZP-CSI-RS resources counted as active CSI-RS for a particular measurement may include the number of CSI-RS resources within a slot, or may include a number of CSI-RS resources that carry a burst of CSI-RSs to be measured by the UE. In some embodiments, the NZP-CSI-RS resources may be counted in one of these manners for one or more of the following measurements: L1-RSRP measurements, L1-SINR measurements, pathloss measurements, beam failure detection measurements, radio link monitoring measurements, or new beam identification measurements.

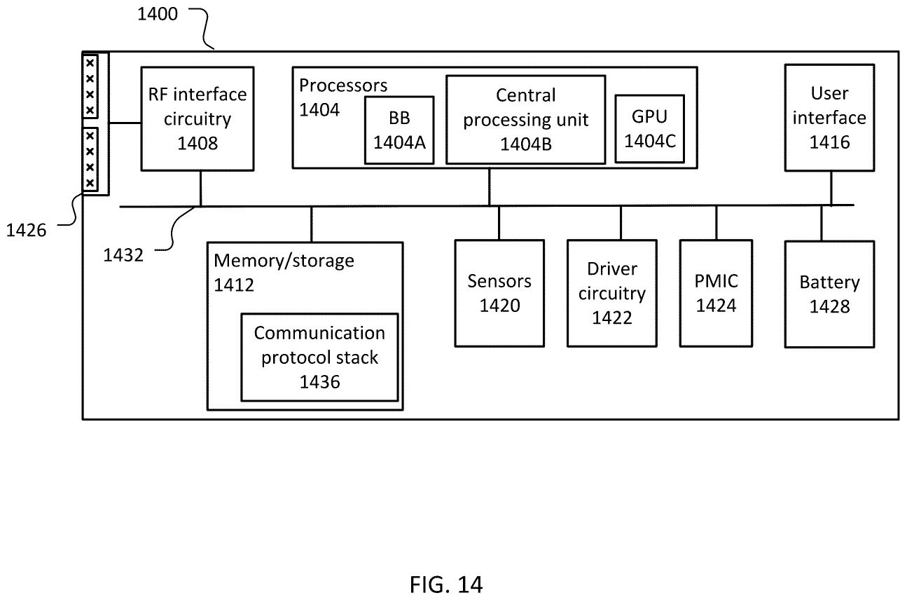

FIG. 14 illustrates an example UE 1400 in accordance with some embodiments. The UE 1400 may be any mobile or non-mobile computing device, such as, for example, a mobile phone, a computer, a tablet, an industrial wireless sensor (for example, a microphone, a carbon dioxide sensor, a pressure sensor, a humidity sensor, a thermometer, a motion sensor, an accelerometer, a laser scanner, a fluid level sensor, an inventory sensor, an electric voltage/current meter, or an actuators), a video surveillance/monitoring device (for example, a camera), a wearable device (for example, a smart watch), or an Internet-of-things (IoT) device.

The UE 1400 may include processors 1404, RF interface circuitry 1408, memory/storage 1412, user interface 1416, sensors 1420, driver circuitry 1422, power management integrated circuit (PMIC) 1424, antenna structure 1426, and battery 1428. The components of the UE 1400 may be implemented as integrated circuits (ICs), portions thereof, discrete electronic devices, or other modules, logic, hardware, software, firmware, or a combination thereof. The block diagram of FIG. 14 is intended to show a high-level view of some of the components of the UE 1400. However, some of the components shown may be omitted, additional components may be present, and different arrangement of the components shown may occur in other implementations.

The components of the UE 1400 may be coupled with various other components over one or more interconnects 1432, which may represent any type of interface, input/output, bus (local, system, or expansion), transmission line, trace, optical connection, etc. that allows various circuit components (on common or different chips or chipsets) to interact with one another.

The processors 1404 may include processor circuitry such as, for example, baseband processor circuitry (BB) 1404A, central processor unit circuitry 1404B, and graphics processor unit circuitry (GPU) 1404C. The processors 1404 may include any type of circuitry or processor circuitry that executes or otherwise operates computer-executable instructions, such as program code, software modules, or functional processes from memory/storage 1412 to cause the UE 1400 to perform operations as described herein.

In some embodiments, the baseband processor circuitry 1404A may access a communication protocol stack 1436 in the memory/storage 1412 to communicate over a 3GPP compatible network. In general, the baseband processor circuitry 1404A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 1408.

The baseband processor circuitry 1404A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 1412 may include one or more non-transitory, computer-readable media that includes instructions (for example, communication protocol stack 1436) that may be executed by one or more of the processors 1404 to cause the UE 1400 to perform various operations described herein. The memory/storage 1412 include any type of volatile or non-volatile memory that may be distributed throughout the UE 1400. In some embodiments, some of the memory/storage 1412 may be located on the processors 1404 themselves (for example, L1 and L2 cache), while other memory/storage 1412 is external to the processors 1404 but accessible thereto via a memory interface. The memory/storage 1412 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1408 may include transceiver circuitry and radio frequency front module (RFEM) that allows the UE 1400 to communicate with other devices over a radio access network. The RF interface circuitry 1408 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 1426 and proceed to filter and amplify (with a low-noise amplifier) the signal. The signal may be provided to a receiver of the transceiver that down-converts the RF signal into a baseband signal that is provided to the baseband processor of the processors 1404.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna structure 1426.

In various embodiments, the RF interface circuitry 1408 may be configured to transmit/receive signals in a manner compatible with NR or other access technologies.

The antenna structure 1426 may include antenna elements to convert electrical signals into radio waves to travel through the air and to convert received radio waves into electrical signals. The antenna elements may be arranged into one or more antenna panels. The antenna structure 1426 may have antenna panels that are omnidirectional, directional, or a combination thereof to enable beamforming and multiple-input, multiple-output communications. The antenna structure 1426 may include microstrip antennas, printed antennas fabricated on the surface of one or more printed circuit boards, patch antennas, phased array antennas, etc. The antenna structure 1426 may have one or more panels designed for specific frequency bands including bands in FR1 or FR2.

The user interface 1416 includes various input/output (I/O) devices designed to enable user interaction with the UE 1400. The user interface 1416 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 1400.

The sensors 1420 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1422 may include software and hardware elements that operate to control particular devices that are embedded in the UE 1400, attached to the UE 1400, or otherwise communicatively coupled with the UE 1400. The driver circuitry 1422 may include individual drivers allowing other components to interact with or control various input/output (I/O) devices that may be present within, or connected to, the UE 1400. For example, driver circuitry 1422 may include a display driver to control and allow access to a display device, a touchscreen driver to control and allow access to a touchscreen interface, sensor drivers to obtain sensor readings of sensors 1420 and control and allow access to sensors 1420, drivers to obtain actuator positions of electro-mechanic components or control and allow access to the electro-mechanic components, a camera driver to control and allow access to an embedded image capture device, audio drivers to control and allow access to one or more audio devices.

The PMIC 1424 may manage power provided to various components of the UE 1400. In particular, with respect to the processors 1404, the PMIC 1424 may control power-source selection, voltage scaling, battery charging, or DC-to-DC conversion.

In some embodiments, the PMIC 1424 may control, or otherwise be part of, various power saving mechanisms of the UE 1400. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1400 may power down for brief intervals of time and thus save power. If there is no data traffic activity for an extended period of time, then the UE 1400 may transition off to an RRC_Idle state, where it disconnects from the network and does not perform operations such as channel quality feedback, handover, etc. The UE 1400 goes into a very low power state and it performs paging where again it periodically wakes up to listen to the network and then powers down again. The UE 1400 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1428 may power the UE 1400, although in some examples the UE 1400 may be mounted deployed in a fixed location, and may have a power supply coupled to an electrical grid. The battery 1428 may be a lithium ion battery, a metal-air battery, such as a zinc-air battery, an aluminum-air battery, a lithium-air battery, and the like. In some implementations, such as in vehicle-based applications, the battery 1428 may be a typical lead-acid automotive battery.

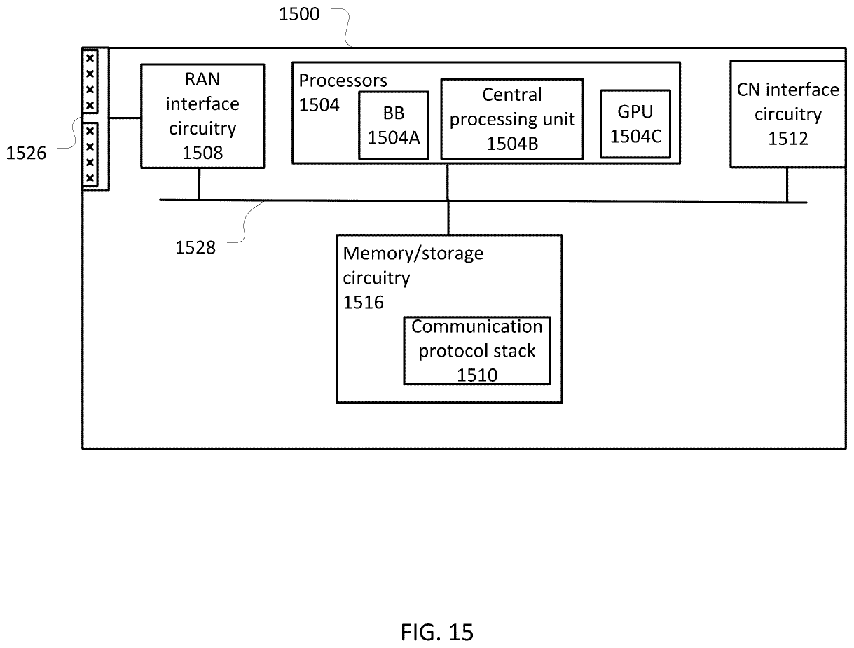

FIG. 15 illustrates an example base station 1500 in accordance with some embodiments. The base station 1500 may include processors 1504, RF interface circuitry 1508, core network (CN) interface circuitry 1512, memory/storage circuitry 1516, and antenna structure 1526.

The components of the base station 1500 may be coupled with various other components over one or more interconnects 1528.

The processors 1504, RF interface circuitry 1508, memory/storage circuitry 1516 (including communication protocol stack 1510), antenna structure 1526, and interconnects 1528 may be similar to like-named elements shown and described with respect to FIG. 14.

The CN interface circuitry 1512 may provide connectivity to a core network, for example, a 5^{th} Generation Core network (5GC) using a 5GC-compatible network interface protocol such as carrier Ethernet protocols, or some other suitable protocol. Network connectivity may be provided to/from the base station 1500 via a fiber optic or wireless backhaul. The CN interface circuitry 1512 may include one or more dedicated processors or FPGAs to communicate using one or more of the aforementioned protocols. In some implementations, the CN interface circuitry 1512 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### Examples

In the following sections, further exemplary embodiments are provided.

Example 1 includes a method of operating a base station, the method comprising: transmitting, to a user equipment (UE), a measurement configuration to configure a channel state information (CSI) measurement over a burst of a plurality of reference signals; transmitting the plurality of reference signals in a time-domain sequence; and scheduling a CSI report in an uplink resource that occurs at least a predetermined processing time after transmitting a last reference signal of the plurality of reference signals in the time-domain sequence.

Example 2 includes a method of example 1 or some other example herein, wherein scheduling the CSI report comprises: transmitting downlink control information (DCI) to the UE, wherein a first reference signal of the plurality of reference signals in the time-domain sequence is transmitted no earlier than the DCI.

Example 3 includes a method of example 1 or some other example herein, wherein the predetermined processing time is to accommodate CSI processing, uplink control information (UCI) multiplexing, or sounding reference signal (SRS) transmission.

Example 4 includes a method of example 1 or some other example herein, wherein the predetermined processing time is four milliseconds or five milliseconds.

Example 5 includes a method of example 1 or some other example herein, further comprising: receiving, from the UE, a UE capability report; and determining the predetermined processing time based on the UE capability report.

Example 6 includes a method of example 5 or some other example herein, wherein the UE capability report indicates a value in milliseconds or symbols and the method further comprises: determining the predetermined processing time as the value.

Example 7 includes a method of example 5 or some other example herein, wherein the UE capability report indicates a plurality of values in milliseconds or symbols that respectively correspond to a plurality of subcarrier spacings (SCSs) and the method further comprises: determining an SCS of a channel or signal; and determining the predetermined processing time corresponds to a value, from the plurality of values, that corresponds to the SCS of the channel or signal.

Example 8 includes a method of example 7 or some other example herein, further comprising: determining a first SCS associated with a downlink channel; determining a second SCS associated with an uplink channel; and determining the SCS is whichever of the first SCS or the second SCS is smaller.

Example 9 includes the method of example 1 or some other example herein, wherein the CSI report is an aperiodic CSI report; and the base station is to schedule the CSI report based on CSI computation delay requirements, wherein the CSI computation delay requirements are low-complexity link adaptation CSI computation requirements, high-complexity link adaptation CSI computation requirements, or beam management CSI computation requirements.

Example 10 includes a method of example 9 or some other example herein, wherein the CSI computation delay requirements are high-complexity link adaptation CSI computation requirements or beam-management CSI computation requirements.

Example 11 includes the method of example 1 or some other example herein, wherein the CSI report is an aperiodic CSI report; and the base station is to schedule the CSI report based on CSI computation delay requirements, wherein the CSI computation delay requirements are low-latency CSI computation requirements, low-complexity link adaptation CSI computation requirements, high-complexity link adaptation CSI computation requirements, or beam management CSI computation requirements.

Example 12 includes the method of example 11 or some other example herein, wherein the CSI computation delay requirements are low-latency CSI computation requirements, the CSI report is to be transmitted in a physical uplink shared channel (PUSCH) transmission that does not carry uplink shared channel data or hybrid automatic repeat request (HARQ) information.

Example 13 includes a method of example 12 or some other example herein, wherein: the CSI report is not to be multiplexed with other uplink control information (UCI) to be transmitted in the PUSCH transmission; and the CSI report is associated with a subcarrier spacing that is less than 120 kilohertz.

Example 14 includes the method of example 11 or some other example herein, wherein: the CSI computation delay requirements are low-latency CSI computation requirements; and the UE is to measure the burst of the plurality of reference signals in one or more CSI processing units (CPUs) and is not to perform any other CSI measurements in any other CPUs while measuring the burst of the plurality of reference signals.

Example 15 includes a method of example 1 or some other example herein, wherein the CSI report is an aperiodic-CSI (AP-CSI) report and the method further comprises: receiving, from the UE, a relaxation value to be used for enhanced AP-CSI reporting, the relaxation value to indicate a number of symbols; and scheduling the AP-CSI report based on the relaxation value.

Example 16 includes the method of example 15 or some other example herein, further comprising: receiving, from the UE, a plurality of relaxation values corresponding to a plurality of subcarrier spacings (SCSs); determining an SCS of a channel or signal; and selecting the relaxation value from the plurality of relaxation values based on the SCS.

Example 17 includes a method of example 16 or some other example herein, further comprising: determining a first SCS associated with downlink control information (DCI) that schedules the CSI report; determining a second SCS associated with the plurality of reference signals; determining a third SCS associated with a physical uplink shared channel (PUSCH) transmission that carries the CSI report; and determining the SCS is a smallest value from the first SCS, the second SCS, and the third SCS.

Example 18 includes a method of operating a user equipment (UE), the method comprising: determining a number of channel state information processing units (CPUs) the UE is capable of supporting; transmitting an indication of the number to a base station; receiving, from the base station, a measurement configuration to configure a CSI measurement over a burst of a plurality of reference signals; and performing the CSI measurement on the plurality of reference signals.

Example 19 includes the method of example 18 or some other example herein, wherein the number is a first number and the method further comprises: determining a second number of channel measurement resources (CMRs) that the UE is capable of measuring per CPU; and transmitting, to the base station, an indication of the second number.

Example 20 includes a method of example 18 or some other example herein, wherein the CSI report is a low-latency aperiodic CSI report and the method further comprises: occupying all CPUs of a slot to perform the CSI measurement.

Example 21 includes a method of operating a base station, the method comprising: receiving, from a user equipment (UE), an indication of a maximum number of active channel state information (CSI)-reference signal (RS) resources the UE is capable of supporting; determining an active CSI-RS duration; and transmitting, to the UE, an indication of a plurality of non-zero-power (NZP) CSI-RS resources that are to be measured by the UE within the active CSI-RS duration, wherein the plurality is equal to or less than the maximum number.

Example 22 includes the method of example 21 or some other example herein, wherein the NZP CSI-RS resources are periodic NZP CSI-RS resources and the method further comprises: transmitting a radio resource control (RRC) configuration message to configure a periodic CSI-RS report; and transmitting an RRC release message to release the periodic CSI-RS report, wherein the active CSI-RS duration is a time between transmitting the RRC configuration message and transmitting the RRC release message.

Example 23 includes the method of example 21 or some other example herein, wherein the NZP CSI-RS resources are aperiodic NZP CSI-RS resources and the method further comprises: transmitting downlink control information (DCI) to trigger an aperiodic CSI report; and receiving a physical uplink shared channel (PUSCH) transmission that includes the aperiodic CSI report, wherein the active CSI-RS duration is a time between transmitting the DCI and receiving the PUSCH transmission.

Example 24 includes the method of example 21 or some other example herein, wherein the NZP CSI-RS resources are semi-persistent NZP CSI-RS resources and the method further comprises: transmitting a first media access control—control element (MAC-CE) to activate a semi-persistent CSI report; and transmitting a second MAC-CE to deactivate the semi-persistent CSI report, wherein the active CSI-RS duration is a time between transmitting the first MAC-CE and transmitting the second MAC-CE.

Example 25 includes the method of example 21 or some other example herein, further comprising: configuring the UE with a measurement based on a burst of reference signals to be transmitted in one or more slots; wherein the active CSI-RS duration is a time corresponding to one slot of the one or more slots.

Example 26 includes the method of example 21 or some other example herein, further comprising: configuring the UE with a measurement based on a burst of reference signals to be transmitted in one or more slots, wherein the active CSI-RS duration is a time corresponding to the one or more slots.

Example 26 includes the method of example 25 or 26, wherein the measurement is a layer 1—reference signal received power (RSRP) measurement, a layer 1—signal to interference and noise ratio (SINR) measurement, a pathloss measurement, a beam failure detection measurement, a radio link monitoring measurement, or a new beam identification measurement.

Example 27 may include an apparatus comprising means to perform one or more elements of a method described in or related to any of examples 1-26, or any other method or process described herein.

Example 28 may include one or more non-transitory computer-readable media comprising instructions to cause an electronic device, upon execution of the instructions by one or more processors of the electronic device, to perform one or more elements of a method described in or related to any of examples 1-26, or any other method or process described herein.

Example 29 may include an apparatus comprising logic, modules, or circuitry to perform one or more elements of a method described in or related to any of examples 1-26, or any other method or process described herein.

Example 30 may include a method, technique, or process as described in or related to any of examples 1-26, or portions or parts thereof.

Example 31 may include an apparatus comprising: one or more processors and one or more computer-readable media comprising instructions that, when executed by the one or more processors, cause the one or more processors to perform the method, techniques, or process as described in or related to any of examples 1-26, or portions thereof.

Example 32 may include a signal as described in or related to any of examples 1-26, or portions or parts thereof.

Example 33 may include a datagram, information element, packet, frame, segment, PDU, or message as described in or related to any of examples 1-26, or portions or parts thereof, or otherwise described in the present disclosure.

Example 34 may include a signal encoded with data as described in or related to any of examples 1-26, or portions or parts thereof, or otherwise described in the present disclosure.

Example 35 may include a signal encoded with a datagram, IE, packet, frame, segment, PDU, or message as described in or related to any of examples 1-26, or portions or parts thereof, or otherwise described in the present disclosure.

Example 36 may include an electromagnetic signal carrying computer-readable instructions, wherein execution of the computer-readable instructions by one or more processors is to cause the one or more processors to perform the method, techniques, or process as described in or related to any of examples 1-26, or portions thereof.

Example 37 may include a computer program comprising instructions, wherein execution of the program by a processing element is to cause the processing element to carry out the method, techniques, or process as described in or related to any of examples 1-26, or portions thereof.

Example 38 may include a signal in a wireless network as shown and described herein.

Example 39 may include a method of communicating in a wireless network as shown and described herein.

Example 40 may include a system for providing wireless communication as shown and described herein.

Example 41 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method of operating a base station, the method comprising:
transmitting, to a user equipment (UE), a measurement configuration to configure a channel state information (CSI) measurement over a burst of a plurality of reference signals;
transmitting the plurality of reference signals in a time-domain sequence; and
scheduling a CSI report in an uplink resource that occurs at least a predetermined processing time after transmitting a last reference signal of the plurality of reference signals in the time-domain sequence.

2. The method of claim 1, further comprising:
determining the UE does not support a low-latency CSI report for CSI measurement over the burst of the plurality of reference signals; and
scheduling the CSI report based on said determining the UE does not support the low-latency CSI report.

3. The method of claim 2, wherein scheduling the CSI report based on said determining the UE does not support the low-latency CSI report comprises:
scheduling the CSI report based on high-complexity link adaptation CSI computation requirements.

4. The method of claim 1, wherein scheduling the CSI report comprises:
transmitting downlink control information (DCI) to the UE, wherein a first reference signal of the plurality of reference signals in the time-domain sequence is transmitted no earlier than the DCI.

5. The method of claim 1, wherein the predetermined processing time is to accommodate CSI processing, uplink control information (UCI) multiplexing, or sounding reference signal (SRS) transmission.

6. The method of claim 1, wherein the predetermined processing time is four milliseconds or five milliseconds.

7. The method of claim 1, further comprising:
receiving, from the UE, a UE capability report; and
determining the predetermined processing time based on the UE capability report.

8. The method of claim 7, wherein the UE capability report indicates a value in milliseconds or symbols and the method further comprises:
determining the predetermined processing time as the value.

9. The method of claim 7, wherein the UE capability report indicates a plurality of values in milliseconds or symbols that respectively correspond to a plurality of subcarrier spacings (SCSs) and the method further comprises:
determining an SCS of a channel or signal; and
determining the predetermined processing time corresponds to a value, from the plurality of values, that corresponds to the SCS of the channel or signal.

10. The method of claim 1, wherein the CSI report is an aperiodic CSI report; and the base station is to schedule the CSI report based on high-complexity link adaptation CSI computation requirements.

11. The method of claim 1, wherein the CSI report is an aperiodic CSI report; and the base station is to schedule the CSI report based on CSI computation delay requirements, wherein the CSI computation delay requirements are low-latency CSI computation requirements, low-complexity link adaptation CSI computation requirements, high-complexity link adaptation CSI computation requirements, or beam management CSI computation requirements.

12. The method of claim 11, wherein the CSI computation delay requirements are low-latency CSI computation requirements, the CSI report is to be transmitted in a physical uplink shared channel (PUSCH) transmission that does not carry uplink shared channel data or hybrid automatic repeat request (HARQ) information.

13. The method of claim 11, wherein:
the CSI computation delay requirements are low-latency CSI computation requirements; and
the UE is to measure the burst of the plurality of reference signals in one or more CSI processing units (CPUs) and is not to perform any other CSI measurements in any other CPUs while measuring the burst of the plurality of reference signals.

14. The method of claim 1, wherein the CSI report is an aperiodic-CSI (AP-CSI) report and the method further comprises:
receiving, from the UE, a relaxation value to be used for enhanced AP-CSI reporting, the relaxation value to indicate a number of symbols; and
scheduling the AP-CSI report based on the relaxation value.

15. The method of claim 14, further comprising:
receiving, from the UE, a plurality of relaxation values corresponding to a plurality of subcarrier spacings (SCSs);
determining an SCS of a channel or signal; and
selecting the relaxation value from the plurality of relaxation values based on the SCS.

16. One or more non-transitory, computer-readable media having instructions, that, when executed by one or more processors, cause a user equipment (UE) to:
determine a channel measurement resource (CMR) processing capability of a channel state information processing unit (CPU) of the UE;
transmit an indication of CMR processing capability to a base station;
receive, from the base station, a measurement configuration to configure a channel state information (CSI) measurement over a burst of a plurality of reference signals; and
perform the CSI measurement on the plurality of reference signals.

17. The one or more non-transitory, computer-readable media of claim 16, wherein the CMR processing capability is a number of CPUs to be occupied in processing one or more CMRs.

18. The one or more non-transitory, computer-readable media of claim 16, wherein the instructions, when executed, further cause the UE to:
determine a number of CPUs the UE is capable of supporting; and
transmit an indication of the number to a base station.

19. The one or more non-transitory, computer-readable media of claim 16, wherein the CSI measurement is an aperiodic CSI reference signal measurement.

20. The one or more non-transitory, computer-readable media of claim 16, wherein the CSI report is a low-latency aperiodic CSI report and the instructions, when executed, further cause the UE to:
occupy all CPUs of a slot to perform the CSI measurement.
